(19) United States
(12) Patent Application Publication
(10) Pub. No.: US 2016/0188128 A1
(43) Pub. Date: Jun. 30, 2016

(54) ELECTRONIC DEVICE DISPLAY AND CONTROL METHOD AND DISPLAY SYSTEM

(71) Applicant: TRONXYZ TECHNOLOGY CO., LTD., Shenzhen (CN)

(72) Inventors: Jin ZHAN, Shenzhen (CN); Yuqing ZENG, Shenzhen (CN); Dehua LUO, Shenzhen (CN)

(73) Assignee: TRONXYZ TECHNOLOGY CO., LTD.

(21) Appl. No.: 14/792,899

(22) Filed: Jul. 7, 2015

(30) Foreign Application Priority Data
Dec. 31, 2014 (CN) 2014-10851589.6
Dec. 31, 2014 (CN) 2014-10855277.2
Dec. 31, 2014 (CN) 2014-10855973.3

(51) Int. Cl. G06F 3/0482; G06F 3/0484; G06F 3/0481

(52) U.S. Cl. CPC G06F 3/0482; G06F 3/04817; G06F 3/04842

(57) ABSTRACT

A display method of an electronic device is provided. The method includes arranging a plurality of icons corresponding to a plurality of applications installed on the electronic device in a closed loop and displaying the plurality of icons arranged in the closed loop. The method also includes receiving control information transmitted from an external control terminal, wherein the control information carries application information. Further, the method includes adjusting a position of a selected application icon in the closed loop based on the received control information, such that the selected application icon is at a position closest to a viewing side of the electronic device, wherein the selected application icon is the icon of the selected application corresponding to the application information carried in the control information. In addition, the method includes displaying the selected application icon at the position closest to the viewing side of the electronic device.

### CROSS-REFERENCES TO RELATED APPLICATIONS

This application claims priority of Chinese Application No. 201410851589.6, filed on Dec. 31, 2014, Chinese Application No. 201410855973.3, filed on Dec. 31, 2014, and Chinese Application No. 201410855277.2, filed on Dec. 31, 2014, the entire contents of all of which are hereby incorporated by reference.

### FIELD OF THE INVENTION

The present disclosure generally relates to the field of display technologies and, more particularly, relates to electronic device display and control methods of the electronic device displays and display systems.

### BACKGROUND

In current technologies, an electronic device often displays icons corresponding to installed applications through a liquid-crystal display (LCD) screen. For example, a television displays icons corresponding to various installed programs through its main interface, and a user can select an icon corresponding to a function that the user wants to control by using a remote control. For another example, a personal computer (PC), a pad or a smart phone also displays icons corresponding to various installed programs through its main interface, and a user can control functions corresponding to different icons by using a mouse or other control devices. When various electronic devices display icons, the electronic devices usually arrange the icons according to a criss-cross manner. When a user controls the icons through a mouse or other control devices, no matter whether an icon is selected or not selected, the position of the icon is kept unchanged. Such display method may affect user interaction experience during the user controls the icons using a control device.

Further, currently, there are some control devices (also called as control terminals) for the electronic devices, such as a remote control of a TV, or a mobile terminal for controlling smart appliances. When these control devices are used to control the electronic device, a user inputs control information through the control device. Then, the control device transmits the received control information to the electronic device through a wired or wireless mode. After the electronic device receives the control information transmitted from the control device, the electronic device parses the control information and performs a corresponding control instruction.

With the development of wireless communication technologies, the control device transmits the control information through a wireless mode has gradually become mainstream. However, due to range or signal strength reasons, the control information may not be successfully transmitted to the electronic device to be controlled when a wireless mode is used. In this case, even if the user continues to input control information to the control device, because the electronic device fails to receive the control information, the electronic device does not respond to the control information. However, at this time, the user does not know the reason why the electronic device does not respond. Thus, the control efficiency of the user is reduced and the user interactive experience is affected.

The disclosed display and control methods of the electronic device and display systems are directed to solve one or more problems set forth above and other problems.

### BRIEF SUMMARY OF THE DISCLOSURE

One aspect of the present disclosure includes an electronic device display method. The method includes arranging a plurality of icons corresponding to a plurality of applications installed on the electronic device in a closed loop and displaying the plurality of icons arranged in the closed loop. The method also includes receiving control information transmitted from an external control terminal, wherein the control information carries application information for identifying a selected application corresponding to a selected application icon. Further, the method includes adjusting a position of the selected application icon in the closed loop based on the received control information, such that the selected application icon is at a position closest to a viewing side of the electronic device, wherein the selected application icon is the icon of the selected application corresponding to the application information carried in the control information. In addition, the method includes displaying the selected application icon at the position closest to the viewing side of the electronic device.

Another aspect of the present disclosure includes an electronic device control method. The method includes displaying a plurality of control icons corresponding to icons of applications installed on the electronic device. The method also includes receiving control information inputted by a user, wherein the control information carries application information for identifying a selected application corresponding to a selected application icon. Further, the method includes sending the received control information to the electronic device, such that the electronic device adjusts a position of the selected application icon in a closed loop based on the application information carried in the control information and displays the selected application icon, wherein the selected application icon is the icon of the selected application corresponding to the application information.

Another aspect of the present disclosure includes a display system. The system includes an electronic device configured to display a plurality of icons corresponding to a plurality of applications installed on the electronic device, wherein the electronic device further includes a display module configured to arrange the plurality of icons corresponding to the plurality of applications installed on the electronic device in a closed loop and display the plurality of icons arranged in the closed loop, a receiving module configured to receive control information transmitted from an external control terminal, wherein the control information carries application information for identifying a selected application corresponding to a selected application icon, and an icon position adjusting module configured to adjust a position of the selected application icon in the closed loop based on the received control information, such that the selected application icon is at a position closest to a viewing side of the electronic device, wherein the selected application icon is the icon of the selected application corresponding to the application information carried in the control information. The display module is further configured to display the selected application icon at the position closest to the viewing side of the electronic device. The system also includes the control terminal configured to control the electronic device, wherein the control terminal further includes a display module configured to display control icons, wherein the control icons correspond to the plurality of icons of the plurality of applications installed on the electronic device, and a transmission module configured to receive the control information inputted by a user and transmit the control information to the electronic device, such that the electronic device adjusts the position of the selection application icon based on the application information carried in the control information.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic diagram of an exemplary electronic device displaying icons consistent with the disclosed embodiments;

FIG. 2 illustrates a flow chart of an exemplary display process of an electronic device consistent with the disclosed embodiments;

FIG. 3 illustrates a flow chart of another exemplary display process of an electronic device consistent with the disclosed embodiments;

FIG. 4 illustrates a schematic diagram of an exemplary electronic device displaying icons consistent with the disclosed embodiments;

FIG. 5 illustrates a schematic diagram of another exemplary electronic device displaying icons consistent with the disclosed embodiments;

FIG. 6 illustrates a flow chart of another exemplary display process of an electronic device consistent with the disclosed embodiments;

FIG. 7 illustrates a flow chart of an exemplary control process of an electronic device consistent with the disclosed embodiments;

FIG. 8 illustrates a flow chart of another exemplary control process of an electronic device consistent with the disclosed embodiments

FIG. 9 illustrates a block diagram of an exemplary electronic device consistent with the disclosed embodiments;

FIG. 10 illustrates a block diagram of another exemplary electronic device consistent with the disclosed embodiments;

FIG. 11 illustrates a block diagram of an exemplary control terminal for controlling an electronic device consistent with the disclosed embodiments; and

FIG. 12 illustrates a block diagram of an exemplary touch terminal consistent with the disclosed embodiments;

FIG. 13 illustrates a schematic diagram of an exemplary folding-type electronic device; and

FIG. 14 illustrates an exemplary computing system consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

According to the disclosed embodiments of the present invention, a display system may be provided. The display system may include an electronic device and a control terminal, and may be implemented on any appropriate computing circuitry platform. The electronic device may be configured to display a plurality of icons corresponding to a plurality of applications installed on the electronic device. The control terminal configured to control the electronic device. FIG. 14 illustrates an exemplary computing system consistent with the disclosed embodiments.

As shown in FIG. 14, the computing system 1400 may include a processor 1402, a storage medium 1404, a display 1406, a communication module 1408, a database 1410, and peripherals 1412. Certain devices may be omitted and other devices may be included.

Processor 1402 may include any appropriate processor or processors. Further, processor 1402 can include multiple cores for multi-thread or parallel processing. Storage medium 1404 may include memory modules, such as ROM, RAM, flash memory modules, and mass storages, such as CD-ROM and hard disk. Storage medium 1404 may store computer programs for implementing various processes, when the computer programs are executed by processor 1402.

Further, peripherals 1412 may include various sensors and other I/O devices, such as keyboard and mouse, and communication module 1408 may include certain network interface devices for establishing connections through communication networks. Database 1410 may include one or more databases for storing certain data and for performing certain operations on the stored data, such as an operation for adjusting a position of a selected application icon.

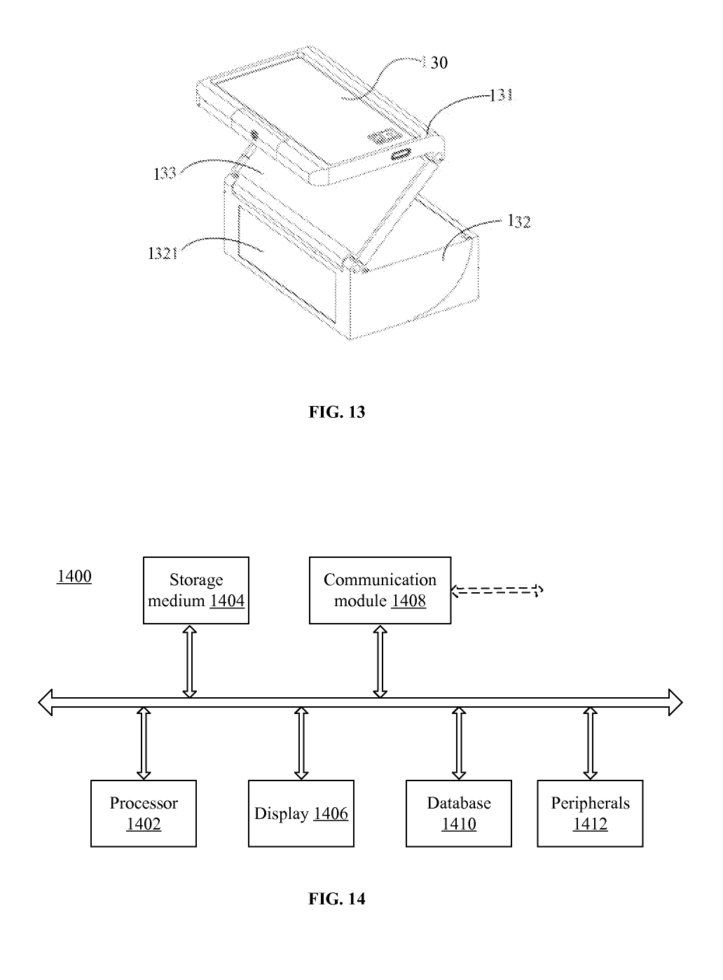

A display method of an electronic device provided in this disclosure can be applied to an electronic device having a display screen, such as a TV, a personal computer (PC), a mobile terminal, and other electronic devices including a display screen (e.g., electronic devices including a display screen and a transflective device). For example, an electronic device may also be a folding-type electronic device. FIG. 13 illustrates a schematic diagram of a folding-type electronic device.

As shown in FIG. 13, the folding-type electronic device 130 may include an upper support member 131, a lower support member 132, and a transflective device 133. The transflective device 133 is connected respectively to the upper support member 131 and the lower support member 132 through a connection mechanism. The upper support member 131 is configured to contain an electronic display device 130. Further, a display screen may be installed on the upper support member 131.

The lower support member 132 is configured to support the transflective device 133 and the upper support member 131. A touch screen 1321 may be installed on the lower support member 132. The user may control the image displayed by the folding-type electronic device 130 through the touch screen 1321. However, if the user controls the image displayed by the folding-type electronic device 130 through the touch screen 1321, the user may not have a desired view during the control process, which may reduce the interactive experience of the user. Also, the size of the touch screen 1321 installed on the lower support member 132 may be insufficient. Therefore, a display screen/control device based control method may be used for controlling the folding-type electronic device.

The imaging principle of the electronic device including the display screen and the transflective device is described in the followings. An image displayed by the display screen, under the action of the transflective device, forms an image for the user to view. By using such an electronic device to display the image, the image viewed by the user is presented in a space in the environment of the electronic device.

Further, as used herein, a viewing side refers to a side from which the user views the image. An icon closest to the viewing side means that the icon displayed by the electronic device is at a position that is closest in a circle to a user at the viewing side. The display process of the electronic device is described in detail through the following specific embodiments.

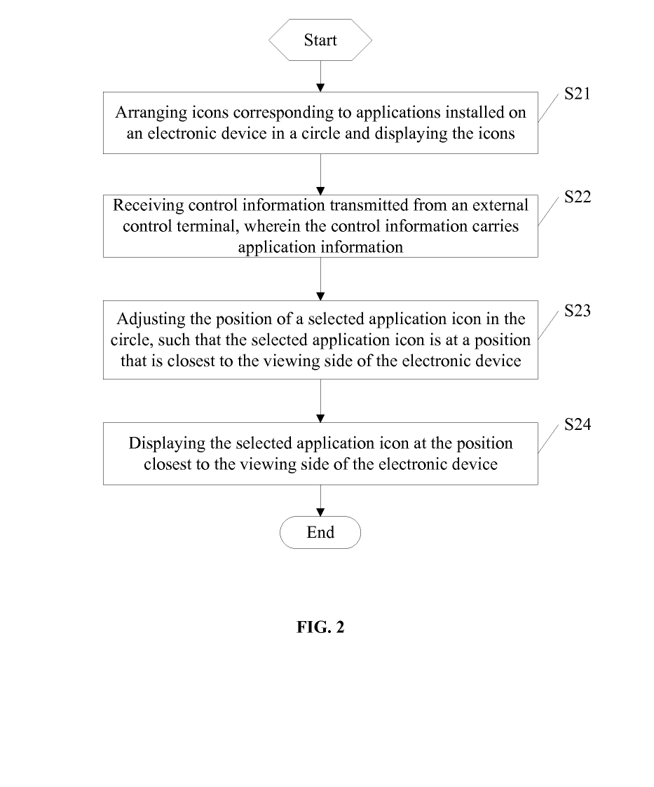

FIG. 2 illustrates a flow chart of an exemplary display process of an electronic device consistent with the disclosed embodiments. As shown in FIG. 2, the display process may include the following steps.

Step S21: a plurality of icons corresponding to a plurality of applications (also called as application software) installed on the electronic device are arranged in a circle and displayed.

The plurality of icons corresponding to the plurality of applications may include APP icons, folder icons, and micro-control icons. The term APP is “a computer program designed for a specific task or use”. In other words, the APP is defined by its functions that enable the users to perform specific tasks. The APP icons may be movie APP icons, music APP icons, game APP icons, etc. The icons corresponding to the applications may be icons on a main interface, or icons on a certain sub-class application.

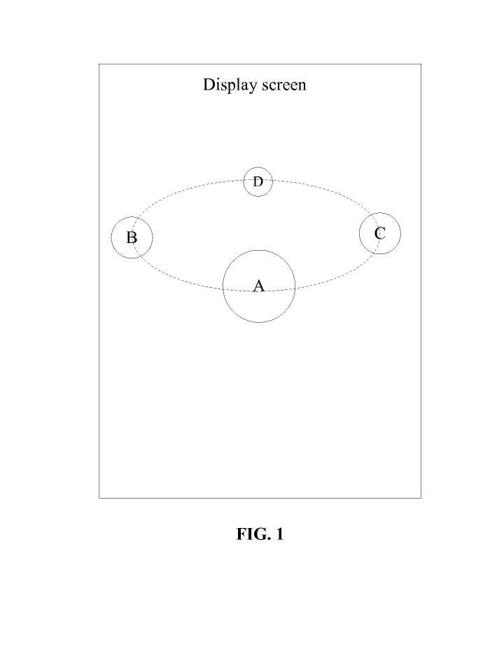

It should be noted that a display screen of an electronic device may arrange the icons installed on the electronic device in any closed loop, such as a circle, an oval, a rectangle, or a square. For example, a display screen of an electronic device arranges APP icons installed on the electronic device in a predetermined circle. The circle may be a circular, elliptical, or other ring shapes. FIG. 1 illustrates a schematic diagram of an exemplary electronic device displaying icons consistent with the disclosed embodiments. As shown in FIG. 1, the icons corresponding to applications are arranged in a circle. Comparing to other shapes, the circular shape is more interesting to users and has a desired user viewing experience.

Returning to FIG. 2, when the display screen displays the APP icons arranged in a circle, a two-dimensional (2D) display mode may be used. Further, a three-dimensional (3D) display mode may also be used, such as an auto-stereoscopic 3D display mode or a glass 3D display mode. On the basis of the electronic device including the transflective device, the icons displayed by the 3D mode, under the action of the transflective device, forms a more realistic circle with the icons, just as a real circle presented in space.

The size and shape of the circle may be predetermined by the electronic device. The APP icons are arranged at intervals in the circle. When the display screen displays the APP icons arranged in the circle, these APP icons may be displayed fixedly at predetermined positions of the circle, or move with a first preset speed along the circle, e.g., a first speed V1.

When these APP icons move with the first speed V1 along the circle, a dynamic display effect is presented. When these APP icons are displayed using the auto-stereoscopic 3D display mode, the dynamic 3D circular APP icons can give the user a desired viewing experience.

Step S22: the electronic device receives control information transmitted from an external control terminal, wherein the control information carries application information.

In Step S22, the control information may be received from the external control terminal, which may be an external device or may be a display screen (e.g., a touch screen) of the electronic device. When the electronic device is a TV, the control information may be received from an external remote terminal. When the electronic device is a mobile terminal (e.g., a smart phone or a PAD), the control information may be received through a display screen of the mobile terminal. The mode of the external control terminal transmitting the control information may include a wired and/or a wireless way. For example, the wired mode may be a USB mode; the wireless mode may include infrared, Bluetooth, radio frequency (RF), Near Field

Communication (NFC), wireless fidelity (Wi-Fi), etc.

The role of the application information carried in the control information may be to identify an application that is currently requested by the external control terminal. The application information may be an identification code, wherein the identification code is used to uniquely identify one of the applications installed on the electronic device.

Step S23: the position of a selected application icon in the circle is adjusted, such that the selected application icon is at a position that is closest to the viewing side of the electronic device. The selected application icon is an icon of the selected application corresponding to the application information.

After receiving the control information, the electronic device extracts the application information carried in the control information, determines the application that corresponds to the application information and is requested by the external control terminal, called a selected application, and searches the icon of the application in a database. The icon of the selected application is called a selected application icon. That is, the application information identifies the selected application that is requested to be controlled.

After the selected application icon is found, the position of the selected application icon in the circle is determined and adjusted, such that the selected application icon is at the position closest to the viewing side of the electronic device. Therefore, the user may have a desired view when viewing the icon corresponding to the application that he/she requests to control, thus improving the user experience in the human-computer interaction process.

Step S24: the selected application icon is displayed at the position closest to the viewing side of the electronic device.

It should be noted that, after the selected application icon is moved to the position that is closest to the viewing side in the circle, when the selected application icon is displayed, the selected application icon is distinguished from other application icons in a certain degree, thus prompting the user that the application requested to be controlled is selected. For example, the selected application icon may be displayed in an enlarged mode or a highlight mode to distinguish with other application icons.

Thus, the electronic device receives the control information, and adjusts the position of the selected application icon in the circle based on the control information, such that the selected application icon is at the position closest to the viewing side of the electronic device. Thus, in the process of controlling the icons displayed by the electronic device, the user can interact with the electronic device, improving interactive experience in the human-computer interaction process and improving the viewing experience.

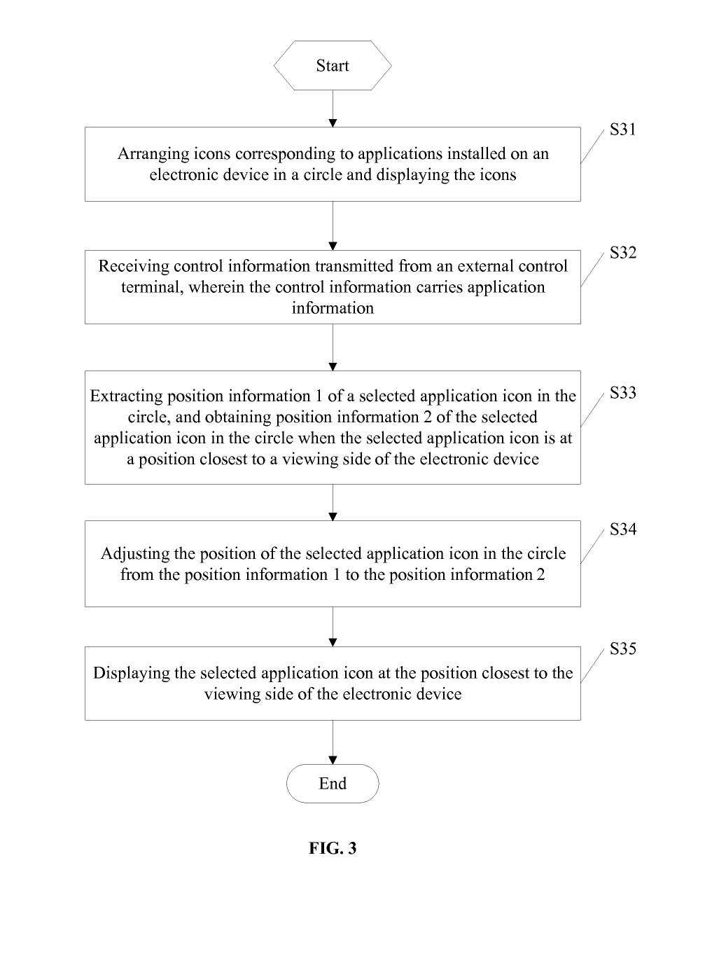

FIG. 3 illustrates a flow chart of another exemplary display process of an electronic device consistent with the disclosed embodiments. As shown in FIG. 3, the process may include the following steps. Steps S31 and S32 are similar to Steps S21 and S22.

Step S31: a plurality of icons corresponding to a plurality of applications installed on the electronic device are arranged in a circle and displayed.

Step S32: the electronic device receives control information transmitted from an external control terminal, wherein the control information carries application information.

Step S33: first position information of the selected application icon in the circle is extracted, and second position information of the selected application icon in the circle when the selected application icon is at a position closest to the viewing side of the electronic device is obtained.

When the first position information of the selected application icon is extracted, a first frame number of the selected application icon in the circle may be extracted. The frame number indicates the position of the selected application icon in the circle. Similarly, when the second position information of the selected application icon is obtained, a second frame number of the selected application icon in the circle may be obtained. Obviously, the first frame number and the second frame number may be the same, or may be different. That is, the value of the first position information and the value of the second position information may be the same or may be different.

When the first frame number and the second frame number are the same, it indicates that the position of the selected application icon in the circle is the closest position to the viewing side of the electronic device. At this time, the position of the selected application icon does not need to be adjusted. That is, the current frame number does not need to be adjusted. When the first frame number and the second frame number are different, it indicates that the position of the selected application icon needs to be adjusted. That is, the current frame number needs to be adjusted. The position of the selected application icon needs to be adjusted from the first frame number to the second frame number.

Step S34: the position of the selected application icon in the circle is adjusted from the first position information to the second position information.

It should be noted that, because icons corresponding to applications installed on the electronic device may be displayed fixedly at the predetermined positions of the circle, or may be moved at the first preset speed along the circle, the position adjustment of the selected application icon may include two categories.

The first category: if the icons corresponding to the applications are arranged at the fixed positions with intervals in the circle, when Step S34 is performed, the selected application icon may be moved along a clockwise or a counterclockwise direction at a second speed, or may be moved along a straight path from the first position information to the second position information at a third speed. The second speed may be equal or not equal to the third speed. In order to improve the user experience, the second speed is greater than the first speed, and the third speed is greater than the first speed.

For example, when the selected application icon is moved along a clockwise or a counterclockwise direction at the second speed, in order to ensure a desired user viewing experience, all the icons corresponding to the applications are moved. Specifically, the icons corresponding to all the applications are moved along the circle at the second speed. When the selected application icon is moved from the first position information to the second position information, the icons corresponding to all the applications are controlled to stop moving. In this mode, during the movement, the electronic device can control a time point for stopping the movement of the icons by monitoring position change of the selected application icon.

Specifically, it is assumed that the arrangement of the icons displayed by the electronic device is shown in FIG. 1 at a T1 time point. At this time, the icon closest to the viewing side is icon A among all the icons. If at this time the electronic device receives the control information and identifies that icon requested by the user to control is icon D, the electronic device needs to move the icon D to the position of the icon A.

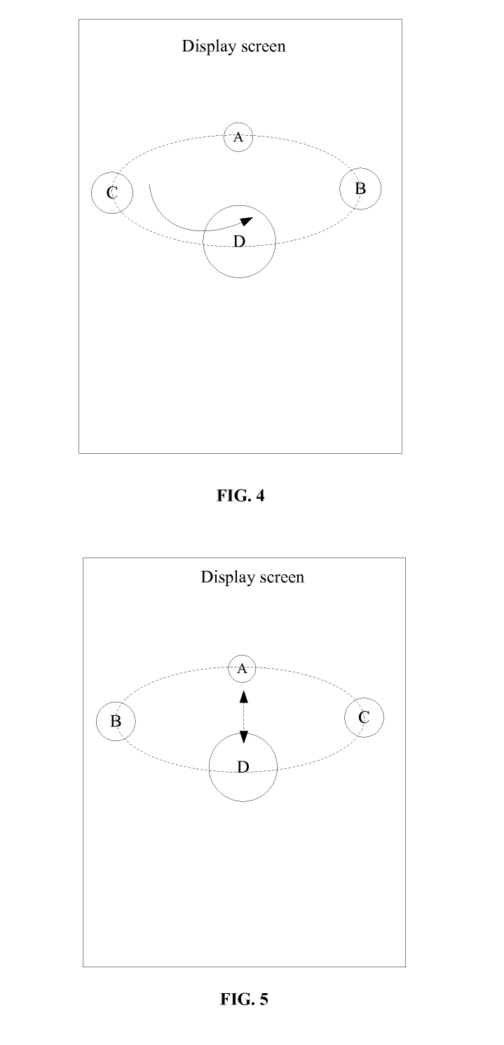

During the process of adjusting the position of the icon D, the user can move all the icons along a clockwise or a counterclockwise direction at a preset speed. When the icon D is moved to the position of icon A, the user stops moving all the icons, as shown in FIG. 4.

For another example, when the selected application icon is moved along the straight path from the first position information to the second position information at the third speed, whether there is another application icon A at the second position information is determined. If the icon A is at the second position information, the position of the selected application icon and the position of the icon A are exchanged along the straight path from the first position information to the second position information. If there does not have another application icon A at the second position information, the selected application moves along the straight path from the first position information to the second position information, and the positions of all other application icons are kept unchanged. For example, if the selected application icon is the icon D, and it is determined that the icon A is at the second position information, the icon A and the icon D can be exchanged along the straight path from the icon A to the icon D , as shown in FIG. 5.

The second category: if the icons corresponding to the applications are moved along the circle at the preset first speed (that is, the icons corresponding to the applications are not arranged at fixed positions), when Step S34 is performed, there may include two modes.

The first mode: the icons corresponding to the applications are moved along the circle at the preset first speed. When the selected application icon is moved from the first position information to the second position information, the icons corresponding to the applications are controlled to stop moving.

For example, when the icons corresponding to the applications are moved along a clockwise or a counterclockwise direction at the first speed, in order to ensure a desired user viewing experience, all the icons corresponding to the applications may be moved. Specifically, the icons corresponding to the applications are moved along the circle at the first speed. When the selected application icon is moved from the first position information to the second position information, the icons corresponding to the applications are controlled to stop moving. In this mode, during the movement, the electronic device can control the time point to stop the movement of the icons by monitoring the position change of the selected application icon.

The second mode: the icons corresponding to the applications are moved at the fourth preset speed. When the selected application icon is moved from the first position information to the second position information, the icons corresponding to the applications are controlled to stop moving.

For example, when the icons corresponding to the applications are moved along a clockwise or a counterclockwise direction at the fourth speed, in order to ensure a desired user viewing experience, all the icons corresponding to the applications may be moved. Specifically, the icons corresponding to the applications are moved along the circle at the fourth speed. When the selected application icon is moved from the first position information to the second position information, the icons corresponding to the applications are controlled to stop moving. In this mode, during the movement, the electronic device can control the time point to stop the movement of the icons by monitoring the position change of the selected application icon. In order to ensure the desired viewing experience and improve response speed, the fourth speed is greater than the first speed.

After Step S34 is performed, that is, after the selected application icon is moved to the position that is closest to the viewing side, Step S35, which is similar to Step S24, is performed.

Step S35: the selected application icon is displayed at the position closest to the viewing side of the electronic device.

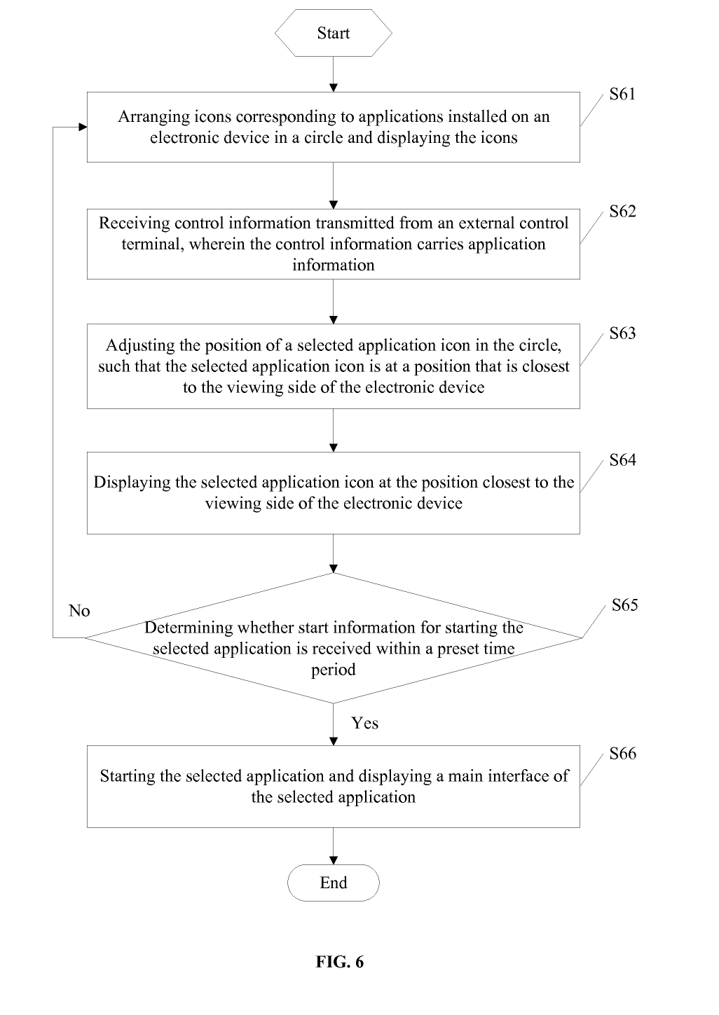

FIG. 6 illustrates a flow chart of another exemplary display process of an electronic device consistent with the disclosed embodiments. The process may include the following steps. Step S61 to Step S64 are similar to Step S21 to Step S24.

Step S61: a plurality of icons corresponding to a plurality of applications installed on the electronic device are arranged in a circle and displayed.

Step S62: the electronic device receives control information transmitted from an external control terminal, wherein the control information carries application information.

Step S63: the position of a selected application icon in the circle is adjusted, such that the selected application icon is at a position that is closest to the viewing side of the electronic device. The selected application icon is an icon of the selected application corresponding to the application information.

Step S64: the selected application icon is displayed at the position closest to the viewing side of the electronic device.

In addition, the process may further include the following steps.

Step S65: it is determined whether start information for starting the selected application is received within a preset time period.

Specifically, if it is determined that the start information for starting the selected application is received within the preset time period, Step S66 is performed. For example, a “play” key may be pressed from a remote control device or the icon corresponding to the selected application may be touched once or twice from a touch-enabled display screen, within the preset time period. If it is determined that the start information for starting the selected application is not received within the preset time period, Step S61 is performed, i.e., returning to the beginning of the process.

Step S66: the selected application is started and a main interface of the selected application is displayed.

It should be noted that, if the icons corresponding to the applications are arranged at fixed positions in the circle with intervals and displayed, when continuing to perform Step S61, the icons corresponding to the applications are still arranged at fixed positions in the circle with intervals and displayed; if the icons corresponding to the applications are moved along the circle at the first preset speed, when continuing to perform Step S61, the icons corresponding to the applications are still moved along the circle at the first preset speed.

Thus, FIG. 1 to FIG. 6 describe the display process of the electronic device after the electronic device receives the control information. In the followings, a process for controlling the electronic device by an external control terminal is described in combination with

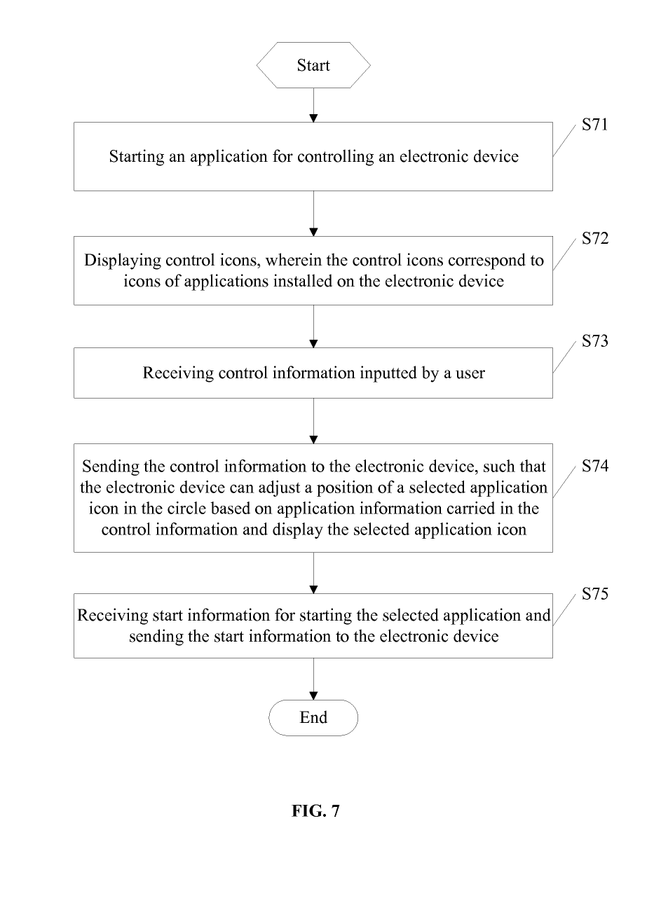

FIG. 7 and FIG. 8. The external control terminal may be a mobile terminal (e.g., a smart phone, a tablet computer, or a personal digit assistant (PDA)). The external control terminal may also be a personal computer (PC), a remote control, or any appropriate device.

FIG. 7 illustrates a flow chart of an exemplary control process of an electronic device consistent with the disclosed embodiments. As shown in FIG. 7, the process may include the following steps.

Step S71: an application for controlling an electronic device on an external control terminal is started.

Step S72: a plurality of control icons are displayed, wherein the plurality of control icons correspond to a plurality of icons of applications installed on the electronic device.

In Step S71 and Step S72, the application for controlling a display function of the electronic device (a control application) is installed on the external control terminal. When the external control terminal receives a signal for starting the control application inputted by a user, the external control terminal starts the control application. Some control icons for controlling the electronic device are displayed on the main interface of the control application. The control icons correspond to the icons of the applications installed on the electronic device.

Specifically, the control icons correspond to functions of the icons of the applications installed on the electronic device. The size and arrangement of the control icons may be the same or different from the icons of the applications installed on the electronic device. For example, each control icon has a mapping relation with one function being executable in the electronic device and is used for processing the function in the electronic device. When a user selects one of the control icons displayed on the control device, the electronic device identifies a particular function associated with the selected control icon. Then, the electronic device executes the identified function by opening the corresponding icon representing the particular function.

Step S73: the external control terminal receives control information inputted by the user.

Step S74: the external control terminal sends the control information to the electronic device, such that the electronic device can adjust position of a selected application icon in the circle based on application information carried in the control information and display the selected application icon.

In Step S73 and Step S74, after the control application interface is displayed, the external control terminal can receive the control information for controlling the electronic device inputted on the application interface by the user. The control information carries the application information, e.g., which application icon is selected by the user. The selected application icon refers to the icon of the selected application corresponding to the application information. The selected application is the application that the external control terminal requests to control.

Specifically, the user may select a control icon from the application interface displayed on the external control terminal, and/or input some control information through the selected control icon. After the external control terminal receives the control information, the external control terminal converts the received control information to the control information that can be identified by the electronic device, and sends the control information to the electronic device through a wired or wireless channel, such that the application corresponding to the control icon can be controlled. After the electronic device receives the control information, the electronic device displays the selected application icon according to methods described in FIG. 2 to FIG. 6.

By performing Step S71 to Step S74, the electronic device is controlled by the external control terminal. Comparing to the traditional control method, this control method does not affect the viewing experience of the user. Also, the position of the selected application icon in the circle can be adjusted through the control terminal. During the control process, the user can interact with the electronic device, thus improving the interactive experience between the user and the electronic device.

It should be noted that, after the position of the selected application icon in the circle is adjusted (that is, after Step S74 is performed), the control process may further include the following step.

Step S75: the external control terminal receives the start information and sends the start information to the electronic device.

The start information is used to start the selected application on the electronic device. For example, when the selected application is a calendar on an electronic device, after a user inputs information “open the calendar” on a remote control, the remote control transmits the information “open the calendar” to the electronic device, such that the electronic device opens the calendar.

FIG. 8 illustrates a flow chart of another exemplary control process of an electronic device consistent with the disclosed embodiments. As shown in FIG. 8, the process may include the following steps. Step S81 and Step S82 are similar to Step S71 and Step S72.

Step S81: a control application for controlling an electronic device on an external control terminal is started.

Step S82: control icons are displayed, and the control icons correspond to icons of applications installed on the electronic device.

In addition, the process may further include the following Step S83.

Step S83: whether the electronic device is in a controllable state is displayed.

The difference between the process shown in FIG. 7 and the process shown in FIG. 8 is that, in FIG. 8, before the external control terminal receives the control information, whether the electronic device is in the controllable state is displayed, such that the information about whether the control information currently inputted is valid is prompted to the user, improving input efficiency and control efficiency of the user. If the electronic device is not in the controllable state, the external control terminal cannot successfully transmit the control information to the electronic device.

Specifically, whether the electronic device is in the controllable state can be marked through displaying different icon information. For example, the controllable state of the electronic device is marked by displaying different colors and/or different sizes of the icon information.

When the controllable state of the electronic device is marked by displaying different colors of the icon information, whether the electronic device is in the controllable state can be marked through displaying icons with different appearances of the electronic device. The electronic device may also be a folding-type electronic device. Because the appearance of the folding-type electronic device is in an open state when the folding-type electronic device is in use, and the appearance of the folding-type electronic device is in a close state when the folding-type electronic device is not in use, whether the folding-type electronic device is in the controllable state can be marked through displaying icon showing whether the appearance of the folding-type electronic device is in the open state or in the close state.

For example, when the icon showing the appearance of the folding-type open electronic device is in the open state, the folding-type electronic device is marked in the controllable state; when the icon showing the appearance of the folding-type electronic device is in the close state, the folding-type electronic device is marked in the uncontrollable state. Thus, the connection state between the folding-type electronic device and the external control terminal can be prompted to the user.

Step S84 to Step S86 are similar to Step S73 to Step S75.

Step S84: the external control terminal receives control information inputted by the user.

Step S85: the external control terminal sends the control information to the electronic device, such that the electronic device can adjust position of a selected application icon in the circle based on application information carried in the control information and display the selected application icon.

Step S86: the external control terminal receives the start information and sends the start information to the electronic device.

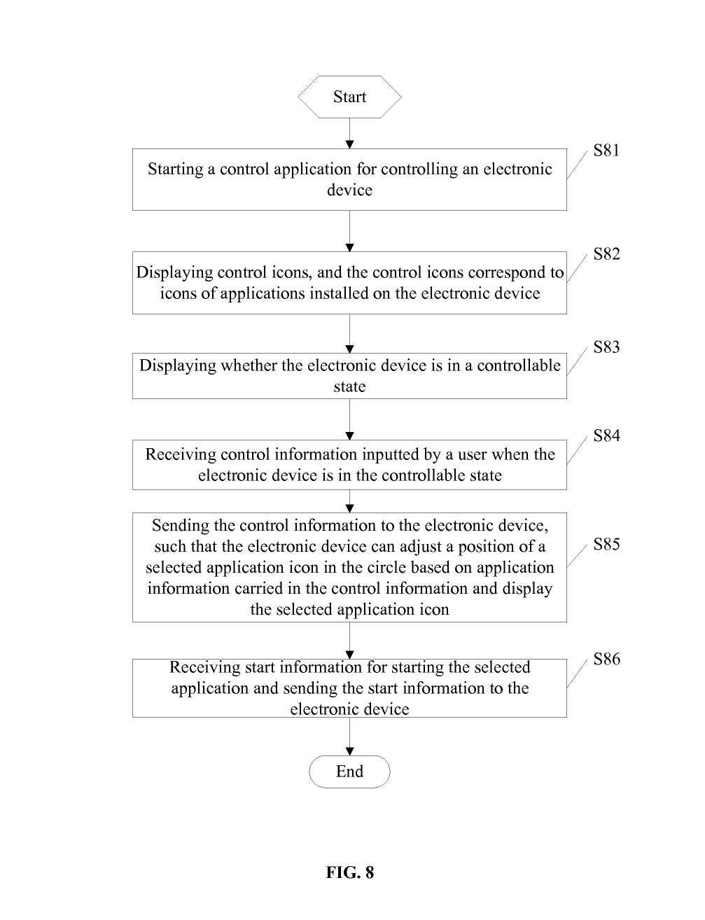

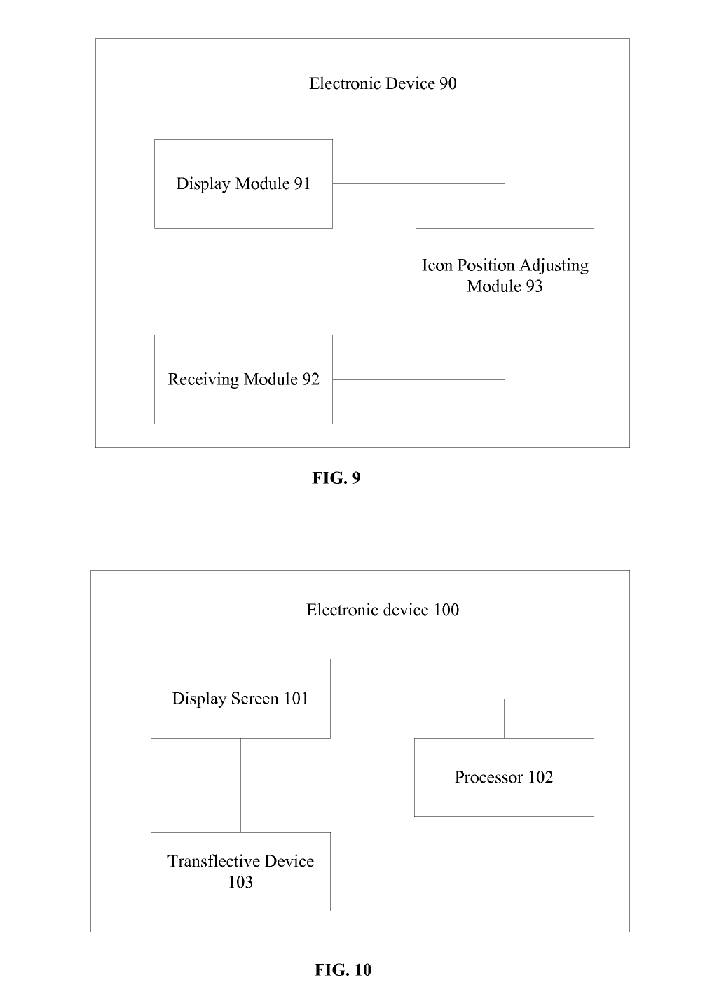

FIG. 9 illustrates a block diagram of an exemplary electronic device consistent with the disclosed embodiments. As shown in FIG. 9, the electronic device 90 may include a display module 91, a receiving module 92 and an icon position adjusting module 93.

The display module 91 may be configured to arrange a plurality of icons corresponding to a plurality of applications installed on the electronic device 90 in a closed loop and display the plurality of icons in a closed loop. It should be noted that a display module of an electronic device may arrange the plurality of icons installed on the electronic device 90 in any closed loop, such as a circle, an oval, a rectangle, a square.

The receiving module 92 may be configured to receive control information transmitted from an external control terminal, wherein the control information carries application information for identifying a selected application corresponding to a selected application icon.

The icon position adjusting module 93 may be configured to adjust position of the selected application icon in the closed loop based on the received control information, such that the selected application icon is at a position closest to a viewing side of the electronic device, wherein the selected application icon is the icon of the selected application corresponding to the application information carried in the control information.

Further, the display module 91 may be also configured to display the selected application icon at the position closest to the viewing side of the electronic device.

When the electronic device 90 displays the selected application icon, in the beginning, the receiving module 92 receives the control information transmitted from the external control terminal. Then, the icon position adjusting module 93, adjusts the position of the selected application icon in the closed loop based on the received control information. At last, the display module 91 displays the selected application icon, such that the selected application icon is displayed at the position that is closest to the viewing side of the electronic device. Thus, when the user controls the icons displayed by the electronic device, the user can interact with the electronic device, improving the interactions between the user and the electronic device.

FIG. 10 illustrates a block diagram of another exemplary electronic device consistent with the disclosed embodiments. As shown in FIG. 10, the electronic device 100 may include a display screen 101, a processor 102, and a transflective device 103.

The display screen 101 may be configured to arrange icons corresponding to applications installed on the electronic device 100 in a closed loop.

The processor 102 may be configured to receive control information transmitted from an external control terminal and adjust position of a selected application icon in the closed loop, such that the selected application icon is at a position closest to the viewing side of the electronic device 100, wherein the control information carries application information, and the selected application icon refers to the icon of the selected application corresponding to the application information.

The display screen 101 may be also configured to display the selected application icon at the position that is closest to the viewing side of the electronic device 100.

The transflective device 103 may be configured to transmit and reflect the icons displayed by the display screen 81. After transmitted and reflected by the transflective device 103, the icons corresponding to the applications can form an image for the user to view. At this time, the image viewed by the user is presented in space.

When the electronic device 100 displays the selected application icon, in the beginning, the processor 102 adjusts the position of the selected application icon in the closed loop based on the received control information transmitted from the external control terminal. Then, the display screen 101 displays the selected application icon, such that the selected application icon is displayed at the position that is closest to the viewing side of the electronic device 100. Thus, the interactive experience between the user and the electronic device 100 is improved.

FIG. 11 illustrates a block diagram of an exemplary control terminal for controlling an electronic device consistent with the disclosed embodiments. As shown in FIG. 11, the control terminal 110 may include a display module 111 and the transmission module 112.

The display module 111 may be configured to display control icons, wherein the control icons correspond to icons of applications installed on the electronic device.

The transmission module 112 may be configured to receive control information inputted by a user and send the control information to the electronic device, such that electronic device can adjust the position of a selected application icon in a closed loop based on application information carried in the control information and display the selected application icon.

The control terminal 110 can control the electronic device through the display module 111 and the transmission module 112. Comparing to the traditional method, this control method does not affect the viewing experience of the user during the control process. Also, the position of the selected application icon in the closed loop can be adjusted through the control terminal, thus improving the interactive experience between the user and the electronic device.

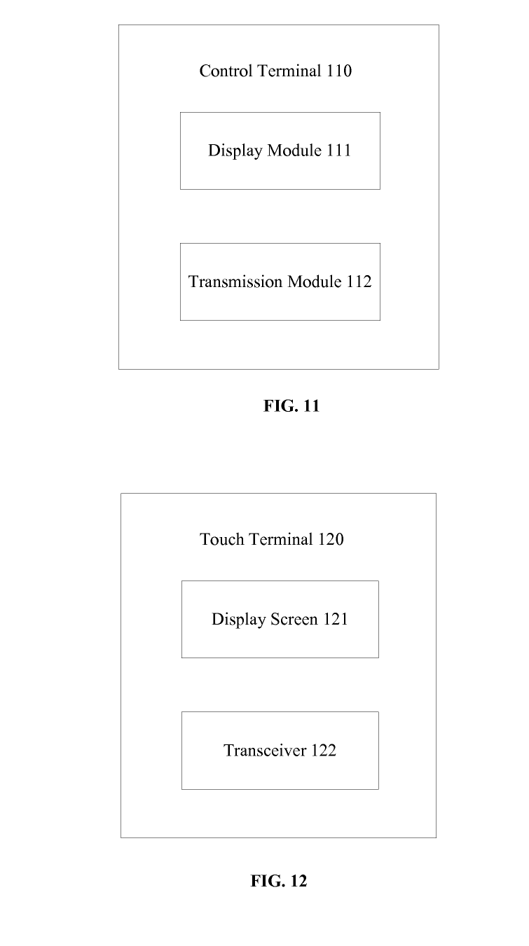

FIG. 12 illustrates a block diagram of an exemplary touch terminal consistent with the disclosed embodiments. As shown in FIG. 12, the touch terminal 120 may include a display screen 121 and a transceiver 122.

The display screen 121 may be configured to display control icons, wherein the control icons correspond to icons of applications installed on an electronic device.

The transceiver 122 may be configured to receive control information inputted by a user, and transmit the control information to the electronic device, such that the electronic device can adjust the position of a selected application icon in the closed loop based on application information carried in the control information and display the selected application icon.

The touch terminal 120 can control the electronic device through the display screen 121 and the transceiver 122. Comparing to the traditional method, this control method does not affect the viewing experience of the user during the control process. Also, the position of the selected application icon in the closed loop can be adjusted through the control terminal, thus improving the user's interactive experience with the electronic device.

Further, although the methods and devices are disclosed for illustrative purposes, similar concept and approach can be applied to other display apparatus. Other applications, advantages, alternations, modifications, or equivalents to the disclosed embodiments are obvious to those skilled in the art.

What is claimed is:

1. An electronic device display method, comprising:
arranging a plurality of icons corresponding to a plurality of applications installed on the electronic device in a closed loop;
displaying the plurality of icons arranged in the closed loop;
receiving control information transmitted from an external control terminal, wherein the control information carries application information for identifying a selected application corresponding to a selected application icon;
based on the received control information, adjusting a position of the selected application icon in the closed loop, such that the selected application icon is at a position closest to a viewing side of the electronic device, wherein the selected application icon is the icon of the selected application corresponding to the application information carried in the control information; and
displaying the selected application icon at the position closest to the viewing side of the electronic device.

2. The method according to claim 2, wherein:
the electronic device is a folding-type electronic device; and
the closed loop is a circle.

3. The method according to claim 1, wherein arranging a plurality of icons further includes:
arranging the plurality of icons corresponding to the plurality of applications at intervals in the closed loop and moving the plurality of icons at a first preset speed along the closed loop; or
arranging the plurality of icons corresponding to the plurality of applications at intervals and at fixed positions of the closed loop.

4. The method according to claim 3, wherein adjusting the position of a selected application icon in the closed loop further includes:
extracting first position information of the selected application icon in the closed loop when the selected application icon is at the current position;
calculating second position information of the selected application icon in the closed loop when the selected application is at the position closest to the viewing side of the electronic device; and
moving the selected application icon from the current position to the position closest to the viewing side of the electronic device based on the first position information and the second position information.

5. The method according to claim 4, wherein, when the plurality of icons corresponding to the plurality of applications are arranged at intervals and at fixed positions of the closed loop, moving the selected application icon further includes:
moving the plurality of icons corresponding to the plurality of applications at a second preset speed along the closed loop; and
when the selected application icon are moved from the current position to the position closest to the viewing side of the electronic device, controlling the plurality of icons corresponding to the plurality of applications to stop moving.

6. The method according to claim 4, wherein, when the plurality of icons corresponding to the plurality of applications are arranged at intervals and at fixed positions of the closed loop, moving the selected application icon further includes:
moving the selected application icon at a preset third speed along a straight path from the current position to the position closest to the viewing side of the electronic device.

7. The method according to claim 4, wherein, when the plurality of icons corresponding to the plurality of applications are moved along the closed loop at the first preset speed, moving selected application icon further includes:
moving the plurality of icons corresponding to the plurality of applications along the closed loop at the first preset speed and controlling the plurality of icons to stop moving when the selected application is moved from the first position information to the second position information; or
moving the plurality of icons corresponding to the plurality of applications along the closed loop at a fourth preset speed and controlling the plurality of icons to stop moving when the selected applications is moved from the first position information to the second position information.

8. The method according to claim 7, further including:
moving the plurality of icons corresponding to the plurality of applications at one of a clockwise direction and a counterclockwise direction along the closed loop.

9. The method according to claim 6, when the plurality of icons corresponding to the
plurality of applications are arranged at intervals and at fixed positions of the closed loop, further including:
determining whether start information for starting the selected application transmitted from the external control terminal is received within a preset time period; and
when it is determined that the start information is received, starting the selected application.

10. The method according to claim 7, when the plurality of icons corresponding to the plurality of applications are moved along the closed loop at the first preset speed, further including:
determining whether start information for starting the selected application transmitted from the external control terminal is received within a preset time period;
when it is determined that the start information is received, starting the selected application; and
when it is determined that the start information is not received within the preset time period, controlling the plurality of icons corresponding to the plurality of applications to continue moving along the closed loop at the first preset speed.

11. The method according to claim 1, wherein displaying the selected application icon at the position closest to the viewing side of the electronic device further includes:
displaying the selected application icon in one of an enlarged mode and a highlight mode.

12. The method according to claim 1, wherein displaying the plurality of icons arranged in the closed loop further includes:
displaying the plurality of icons corresponding to the plurality of applications installed on the electronic device in one of a two-dimensional (2D) display mode and a three-dimensional (3D) display mode.

13. The method according to claim 10, wherein:
the application information is an identification code; and
the identification code is used to uniquely identify an application among the plurality of applications.

14. The method according to claim 10, wherein:
the plurality of icons corresponding to the plurality of applications include app icons, file icons and micro-control icons.

15. An electronic device control method, comprising:
displaying a plurality of control icons corresponding to icons of applications installed on the electronic device;
receiving control information inputted by a user, wherein the control information carries application information for identifying a selected application corresponding to a selected application icon; and
sending the received control information to the electronic device, such that the electronic device adjusts a position of the selected application icon in a closed loop based on the application information carried in the control information and displays the selected application icon, wherein the selected application icon is the icon of the selected application corresponding to the application information.

16. The method according to claim 15, before receiving control information inputted by a user, further including:
displaying whether the electronic device is in a controllable state, wherein the electronic device is a folding-type electronic device.

17. The method according to claim 16, wherein displaying whether the electronic device is in a controllable state further includes:
displaying different icon information to identify whether the electronic device is in the controllable state, wherein the different icon information includes at least one of icon information with different colors and icon information with different sizes.

18. The method according to claim 16, further including:
after the position of the selected application icon is adjusted, receiving start information inputted by the user and transmitting the received start information to the electronic device.

19. A display system, comprising:
an electronic device configured to display a plurality of icons corresponding to a plurality of applications installed on the electronic device, wherein the electronic device further includes:
a display module configured to arrange the plurality of icons corresponding to the plurality of applications installed on the electronic device in a closed loop and display the plurality of icons arranged in the closed loop;
a receiving module configured to receive control information transmitted from an external control terminal, wherein the control information carries application information for identifying a selected application corresponding to a selected application icon;
an icon position adjusting module configured to adjust a position of the selected application icon in the closed loop based on the received control information, such that the selected application icon is at a position closest to a viewing side of the electronic device, wherein the selected application icon is the icon of the selected application corresponding to the application information carried in the control information; and
the display module further configured to display the selected application icon at the position closest to the viewing side of the electronic device; and
the control terminal configured to control the electronic device, wherein the control terminal further includes:
a display module configured to display a plurality of control icons, wherein the plurality of control icons correspond to the plurality of icons of the plurality of applications installed on the electronic device; and
a transmission module configured to receive the control information inputted by a user and transmit the control information to the electronic device, such that the electronic device adjusts the position of the selection application icon in the closed loop based on the application information carried in the control information.

20. The system according to claim 19, wherein the control terminal is further configured to:
display whether the electronic device is in a controllable state, wherein the electronic device is a folding-type electronic device; and
after the position of the selected application icon is adjusted, receive start information inputted by the user and transmit the received start information to the electronic device, such that the selected application is started.
